(19) United States
(12) Patent Application Publication
(10) Pub. No.: US 2026/0163905 A1
(43) Pub. Date: Jun. 11, 2026

(54) PRIORITY-BASED HASH CRACKING FOR NETWORK PENETRATION TESTING

(71) Applicant: Horizon 3 AI, Inc., Dover, DE (US)

(72) Inventors: John Samuel Bass, New Braunfels, TX (US); Zachary Daniel Hanley, Apex, NC (US); John Tyler Orr, Raleigh, NC (US)

(21) Appl. No.: 18/973,355

(22) Filed: Dec. 9, 2024

(51) Int. Cl. H04L 9/40

(52) U.S. Cl. CPC H04L 63/1433

(57) ABSTRACT

A method of priority-based hash cracking for penetration testing is described. Techniques described herein may enable a controller of an autonomous pentesting service to unhash one or more hashes (e.g., password hashes) associated with one or more clients in accordance with one or more queues of hashes with varying priority. The controller may receive hashes from one or more respective autonomous pentesting agents and may sort the received hashes into one or more queues based on a priority of cracking each received hash. For example, the controller may store one or more hashes that may be relatively more valuable to crack in a relatively higher priority queue, and may store one or more hashes that may be relatively less valuable to crack in a relatively lower priority queue. The controller may therefore unhash one or more higher priority hashes prior to cracking one or more lower priority hashes.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities in the network before they can be exploited by an actual malicious actor. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support priority-based hash cracking for penetration testing (“pentesting”).

A method for unhashing password hashes by an apparatus is described. The method may include obtaining a set of password hashes associated with performing one or more penetration tests of one or more clients, storing a first subset of the set of password hashes in a first queue based at least in part on the first subset of the set of password hashes satisfying one or more first criteria associated with performing the one or more penetration tests, the first queue associated with a first priority, storing a second subset of the set of password hashes in a second queue based at least in part on the second subset of the set of password hashes satisfying one or more second criteria, the second queue associated with a second priority lower than the first priority, unhashing, via a hash cracking function and as part of the one or more penetration tests, at least one password hash of the first subset of the set of password hashes based at least in part on the first priority being higher than the second priority, and unhashing, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.

An apparatus for unhashing password hashes is described. The apparatus may include one or more memories storing processor executable code, and one or more processors coupled with the one or more memories. The one or more processors may individually or collectively be operable to execute the code to cause the apparatus to obtain a set of password hashes associated with performing one or more penetration tests of one or more clients, store a first subset of the set of password hashes in a first queue based at least in part on the first subset of the set of password hashes satisfying one or more first criteria associated with performing the one or more penetration tests, the first queue associated with a first priority, store a second subset of the set of password hashes in a second queue based at least in part on the second subset of the set of password hashes satisfying one or more second criteria, the second queue associated with a second priority lower than the first priority, unhash, via a hash cracking function and as part of the one or more penetration tests, at least one password hash of the first subset of the set of password hashes based at least in part on the first priority being higher than the second priority, and unhash, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.

Another apparatus for unhashing password hashes is described. The apparatus may include means for obtaining a set of password hashes associated with performing one or more penetration tests of one or more clients, means for storing a first subset of the set of password hashes in a first queue based at least in part on the first subset of the set of password hashes satisfying one or more first criteria associated with performing the one or more penetration tests, the first queue associated with a first priority, means for storing a second subset of the set of password hashes in a second queue based at least in part on the second subset of the set of password hashes satisfying one or more second criteria, the second queue associated with a second priority lower than the first priority, means for unhashing, via a hash cracking function and as part of the one or more penetration tests, at least one password hash of the first subset of the set of password hashes based at least in part on the first priority being higher than the second priority, and means for unhashing, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.

A non-transitory computer-readable medium storing code for unhashing password hashes is described. The code may include instructions executable by one or more processors to obtain a set of password hashes associated with performing one or more penetration tests of one or more clients, store a first subset of the set of password hashes in a first queue based at least in part on the first subset of the set of password hashes satisfying one or more first criteria associated with performing the one or more penetration tests, the first queue associated with a first priority, store a second subset of the set of password hashes in a second queue based at least in part on the second subset of the set of password hashes satisfying one or more second criteria, the second queue associated with a second priority lower than the first priority, unhash, via a hash cracking function and as part of the one or more penetration tests, at least one password hash of the first subset of the set of password hashes based at least in part on the first priority being higher than the second priority, and unhash, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.

### BRIEF DESCRIPTION OF THE DRAWINGS

FIG. 1 shows an example of a computing environment that supports priority-based hash cracking for penetration testing in accordance with aspects of the present disclosure.

FIG. 2 shows an example of an autonomous pentest map that supports priority-based hash cracking for penetration testing in accordance with aspects of the present disclosure.

FIG. 3 shows an example of a computing environment that supports priority-based hash cracking for penetration testing in accordance with aspects of the present disclosure.

FIG. 4 shows a diagram of a system including a device that supports priority-based hash cracking for penetration testing in accordance with aspects of the present disclosure.

FIG. 5 shows a flowchart illustrating methods that support priority-based hash cracking for penetration testing in accordance with aspects of the present disclosure.

### DETAILED DESCRIPTION

In some examples, one or more agents (e.g., one or more autonomous penetration testing (“pentesting”) agents) associated with one or more clients may obtain (e.g., discover, retrieve) password hashes associated with the respective clients. The one or more agents may provide the hashes to a controller of an autonomous pentesting system that may maintain a list (e.g., a primary list, a primary queue) of password hashes. The controller may add hashes to the list in an order that the hashes are discovered and provided to the controller (e.g., by the respective autonomous pentesting agents). Accordingly, the controller may crack (e.g., unhash, reverse hash, decode) the hashes in the order that the hashes are discovered. In some examples, however, one or more hashes may be relatively more valuable (e.g., relatively faster or less difficult to crack, relatively more likely to result in an operational achievement such as a domain compromise) than some other hashes. In such examples, if the relatively more valuable hashes are discovered after one or more relatively less valuable hashes, the controller may unhash the relatively less valuable hashes first, which may result in increased latency associated with the pentest.

Accordingly, techniques described herein may support methods for priority-based hash cracking for pentesting. For example, a controller of an autonomous pentesting service may unhash one or more hashes (e.g., password hashes) associated with one or more clients in accordance with one or more queues of hashes associated with respective priorities. The controller may receive hashes from one or more respective autonomous pentesting agents and may sort the received hashes into the one or more queues based on a priority of cracking each received hash. For example, the controller may store one or more hashes that may be relatively faster or less difficult to crack in a relatively higher priority queue, and may store one or more hashes that may be relatively slower or more difficult to crack in a relatively lower priority queue. Additionally, or alternatively, the controller may store one or more hashes that may be relatively more valuable to crack (e.g., more likely to result in an operational achievement such as a domain compromise) in a relatively higher priority queue, and may store one or more hashes that may be relatively less valuable to crack in a relatively lower priority queue. The controller may therefore unhash one or more higher priority hashes prior to cracking one or more lower priority hashes.

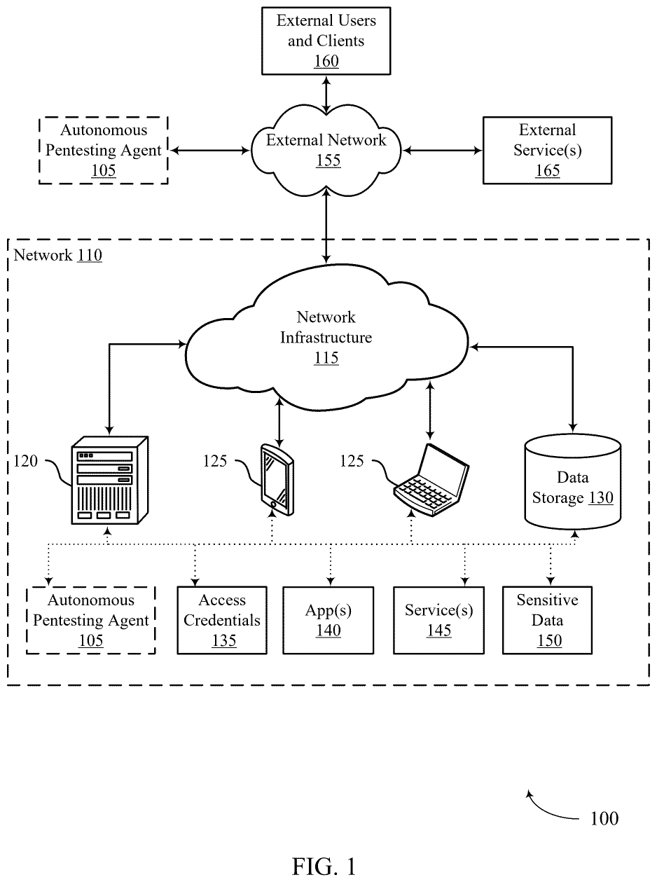

FIG. 1 illustrates an example of a computing environment 100 that supports priority-based hash cracking for penetration testing in accordance with aspects of the present disclosure. The computing environment 100 may include an autonomous pentesting agent 105 that performs an autonomous pentest of a network 110. The network 110 may include one or more devices or systems, such as a network infrastructure 115, server 120, computing devices 125, data storage 130, or any combination thereof. The devices or systems of the network 110 may be configured to access or provide various network information and services, such as access credentials 135, app(s) 140, service(s) 145, sensitive data 150, or any combination thereof.

The network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the network 110 as well as communication between the network 110 (e.g., the private network) and an external network 155 (e.g., the Internet). The network 110 may include aspects of one or more wired networks, one or more wireless networks (e.g., cellular networks), or any combination thereof. The network 110 may include aspects of one or more public networks or private networks, as well as secured or unsecured networks, or any combination thereof. For example, the network 110 may be an example of a private network that includes one or more public-facing or external assets that are accessible via an external network 155. As an example, the external network 155 may refer to the Internet, and users, such as external users and clients 160, may access the network 110 via the external network 155 through a website or application that is on the external network 155. For example, the external users and clients 160, the external service(s) 165, or both may access network information and services via the external network 155 (e.g., via the Internet), including the access credentials 135, app(s) 140, service(s) 145, and sensitive data 150.

The network 110 may be accessible via one or more hosts. For example, hosts may be examples of real or virtual machines that are connected to and capable of accessing the network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the network 110 and outside of the network (e.g., with devices in an external network 155). For example, the server 120 may send data to and receive data from one or more of the computing devices 125. Additionally, or alternatively, hosts may access resources of the network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. As used herein, network assets refer to machines that include network shares. For example, network assets may be examples of machines (e.g., real or virtual machines) that include shares of the network 110, such as file sharing systems. Network assets may be obtained and utilized by attackers to compromise the network 110. The server 120, the computing devices 125, the data storage 130, and the access credentials 135, app(s) 140, service(s) 145, and sensitive data 150 accessible via the devices and systems of the network 110 may all be examples of network assets. For example, physical devices (e.g., servers, computing devices, data storage, etc.) and systems may be considered network assets as well as information, apps, and services accessible through physical devices and systems of the network 110.

Hosts may store, provide, or implement access credentials 135, app(s) 140, service(s) 145, sensitive data 150, or any combination thereof. In some cases, computing devices 125 on the network may access the one or more assets (e.g., access credentials 135, app(s) 140, service(s) 145, sensitive data 150, etc.) via the server 120 (e.g., via a host). Additionally, or alternatively, computing devices 125 may locally store or otherwise access the one or more assets of the network 110. For example, users of the network 110 may access app(s) 140 and service(s) 145 via the computing devices 125 directly or indirectly (e.g., via a connection between the computing devices 125 and the server 120).

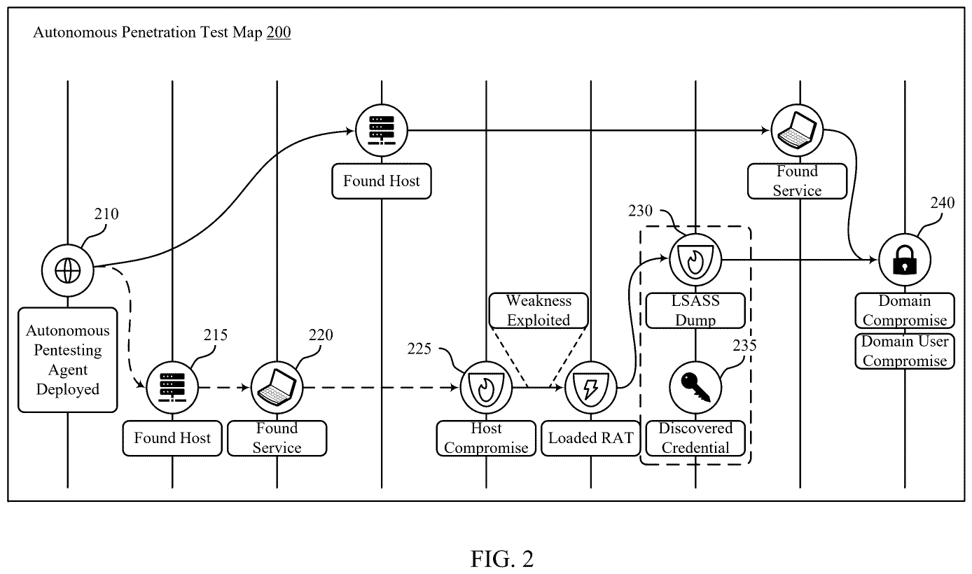

The autonomous pentesting agent 105 may perform a pentest of the network 110. As used herein, a penetration test or a “pentest” may refer to one or more security operations that simulate a cybersecurity attack in order to identify vulnerabilities in the network 110. The autonomous pentesting agent 105 may perform the pentest of the network 110 using one or more artificial intelligence (AI) models. For example, the autonomous pentesting agent 105 may be “autonomous,” as the autonomous pentesting agent 105 may perform the pentest without a requirement of hard-coding, user inputs, or the like and, instead, by using the one or more AI models. The autonomous pentesting agent 105 may identify, via the pentest, security vulnerabilities of the network 110. An example of an output of the pentest may be described in greater detail elsewhere herein, including with reference to FIG. 2.

The autonomous pentesting agent 105 may, via the one or more AI models, determine and implement an attack path for a pentest. For example, the autonomous pentesting agent 105 may identify or select an asset of the network 110 to attempt to access initially and, from that asset, another asset to attempt to access, and so on. In other words, the autonomous pentesting agent 105 may use the one or more AI models to mimic decisions of an attacker. The one or more AI models may output a targeted asset of the network 110 to be subject to an access attempt by the autonomous pentesting agent 105 based on inputs including context of various assets in the network 110. In other words, the one or more AI models may output targeted assets based on the relative position of assets within the network 110, asset types, downstream assets (e.g., accessible after or through accessing a targeted asset), or the like.

The one or more AI models may be trained using data of previous pentests of the network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the network 110 previously or on other networks, or both. The autonomous pentesting agent 105 may perform improved pentests after the one or more AI models are trained using previous pentests of the network 110. That is, as the autonomous pentesting agent 105 learns more about the network 110, the autonomous pentesting agent 105 may perform pentests with higher performance levels (e.g., higher accuracy, higher quantities of potential attack paths, etc.).

In some cases, the pentest may be internal or external to the network 110. For example, the autonomous pentesting agent 105 may be deployed at a host device of the network 110 (e.g., deployed to the server 120 or computing devices 125). In such examples, the autonomous pentesting agent 105 may perform the pentest as an internal user of the network 110. Such internal pentests may be indicative of or emulate internal security threats to the network, such as from employees of an organization or an attacker that has otherwise obtained access to the network 110 internally. Alternatively, the autonomous pentesting agent 105 may be deployed at the external network 155. For example, the autonomous pentesting agent 105 may perform the pentest as an external user of the network 110, such as by accessing external or public-facing assets of the network 110 on the external network 155.

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the network 110 against cybersecurity attacks relative to hard-coded (e.g., automated) or manual (e.g., human operated) pentests.

As described herein, in some examples of the computing environment 100, a controller of an autonomous pentesting service may unhash (e.g., crack, reverse hash, decode) one or more hashes (e.g., password hashes) associated with one or more clients in accordance with one or more priority queues of hashes. For example, the controller may receive hashes from one or more respective autonomous pentesting agents 105 and may sort the received hashes into one or more queues based on a priority of cracking each received hash. Accordingly, the controller may unhash one or more higher priority hashes prior to cracking one or more lower priority hashes. By using priority-based hash cracking as described herein, the controller may support improved network security and reduced latency associated with pentesting. For example, the controller may store one or more hashes that may be relatively faster or less difficult to crack in a relatively higher priority queue, and may store one or more hashes that may be relatively slower or more difficult to crack in a relatively lower priority queue. Additionally, or alternatively, the controller may store one or more hashes that may be relatively more valuable to crack (e.g., more likely to result in an operational achievement such as a domain compromise) in a relatively higher priority queue, and may store one or more hashes that may be relatively less valuable to crack in a relatively lower priority queue. Accordingly, the controller may crack the relatively less difficult hashes or the relatively higher value hashes first, which may reduce a duration for the pentest to result in an operational achievement (e.g., a domain compromise) as compared to a pentest in which the relatively more difficult or lower value hashes may be cracked first. Such an operational achievement associated with a pentest may result in relatively increased network security by enabling the network to identify one or more weaknesses in network security.

FIG. 2 shows an example of an autonomous pentest map 200 that supports priority-based hash cracking for penetration testing in accordance with aspects of the present disclosure. The autonomous pentest map 200 may be an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent.

The autonomous pentest map 200 may include one or more types of events. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent pay perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support methods for priority-based hash cracking. For example, a controller of an autonomous pentesting service may unhash (e.g., crack, reverse hash, decode) one or more hashes (e.g., password hashes) associated with one or more clients in accordance with one or more priority queues of hashes. The controller may receive hashes from one or more respective autonomous pentesting agents 105 and may sort the received hashes into one or more queues based on a priority of cracking each received hash. For example, the controller may store one or more hashes that may be relatively faster or less difficult to crack in a relatively higher priority queue, and may store one or more hashes that may be relatively slower or more difficult to crack in a relatively lower priority queue. Additionally, or alternatively, the controller may store one or more hashes that may be relatively more valuable to crack (e.g., more likely to result in an operational achievement such as a domain compromise) in a relatively higher priority queue, and may store one or more hashes that may be relatively less valuable to crack in a relatively lower priority queue. The controller may therefore unhash one or more higher priority hashes prior to cracking one or more lower priority hashes.

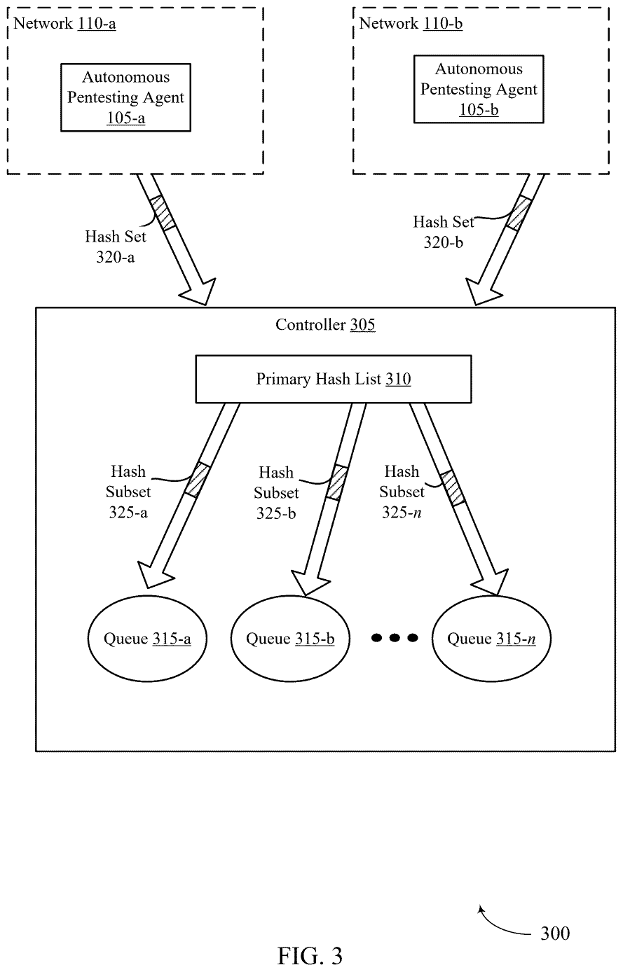

FIG. 3 shows an example of a computing environment 300 that supports priority-based hash cracking for penetration testing in accordance with aspects of the present disclosure. The computing environment 300 may implement or be implemented by the computing environment 100, the autonomous pentest map 200, or both. For example, the computing environment 300 may illustrate one or more networks 110 (e.g., a network 110-a, a network 110-b) that include one or more autonomous pentesting agents 105 (e.g., an autonomous pentesting agent 105-a, an autonomous pentesting agent 105-b), which may perform autonomous pentests of the networks 110. Although the autonomous pentesting agents 105 are shown as internal to the networks 110 in the computing environment 300 of FIG. 3, the autonomous pentesting agents 105 may alternatively be external to the networks 110 and access the networks 110 via the Internet or another external network.

In some examples of the computing environment 300, an autonomous pentesting service may perform a multi-agent pentest on one or more clients (e.g., a first client associated with a network 110-a and a second client associated with a network 110-b). For example, the autonomous pentesting service may deploy an autonomous pentesting agent 105-a to perform a pentest (e.g., a pentesting operation) on the network 110-a and an autonomous pentesting agent 105-b to perform a pentest (e.g., a pentesting operation) on the network 110-b. In some examples, as part of the pentesting operations, the autonomous pentesting agent 105-a and the autonomous pentesting agent 105-b may each obtain (e.g., discover) a set of password hashes (e.g., a hash set 320-a and a hash set 320-b, respectively). The autonomous pentesting agent 105-a and the autonomous pentesting agent 105-b may provide the hash set 320-a and the hash set 320-b to a controller 305 of the autonomous pentesting service. In some examples, the controller 305 may receive one or more additional hash sets 320 from one or more additional autonomous pentesting agents 105 performing pentesting operations on one or more additional networks 110.

In some examples, the controller 305 may maintain a list (e.g., a queue) of hashes received from the autonomous pentesting agents 105. For example, the controller 305 may store the hashes received from the autonomous pentesting agents 105 in an order in which the controller 305 receives the hashes (e.g., in an order in which the hashes were obtained or discovered by the autonomous pentesting agents 105). That is, the controller 305 may store a newly found hash (e.g., a most recently obtained hash) at the end of the list. The controller 305 may perform hash cracking operations on the hashes (e.g., using a hash cracking function) to attempt to crack each hash in the queue in the order in which the hashes are stored in the list (e.g., in the order in which the hashes were found). For example, the controller 305 may use a hash cracking function to attempt to crack a first hash at the top of the list (e.g., a hash that was discovered earlier than one or more other hashes of the list), and may select a next hash in the list to attempt to crack after cracking the first hash.

In some examples, however, one or more hashes in the list may be relatively more valuable to crack or relatively higher priority to crack. For example, the higher priority hashes may be relatively more useful for a respective pentest (e.g., relatively more likely to result in an operational achievement such as a domain compromise or unauthorized access to a network asset) or relatively faster or less difficult to crack, and may therefore result in a relatively faster pentest in examples in which the higher priority hashes are cracked sooner. If such higher priority hashes are discovered after one or more lower priority hashes, the controller 305 may attempt to crack the lower priority hashes first, which may increase a latency associated with performing the pentesting operations.

Techniques described herein may enable the controller 305 to sort (e.g., prioritize) the hashes received from the autonomous pentesting agents 105 into two or more queues 315 that may be associated with respective priorities. For example, the controller 305 may store the hashes received from the autonomous pentesting agents 105 in a primary hash list 310, and may identify a priority of each hash in the primary hash list 310. The controller 305 may therefore store a hash subset 325-a associated with relatively highest priorities in a queue 315-a (e.g., a highest priority queue), a hash subset 325-b associated with relatively lower priorities than the hash subset 325-a in a queue 315-b (e.g., a queue with a relatively lower priority than the highest priority queue), and so on through a hash subset 325-n stored in a queue 315-n (e.g., a lowest priority queue). The controller 305 may accordingly use the hash cracking function to unhash the hash subset 325-a stored in the queue 315-a, to unhash the hash subset 325-b stored in the queue 315-b, and so on through the hash subset 325-n stored in the queue 315-n (e.g., in order of priority). That is, the controller 305 may prioritize hash cracking workloads based on priorities associated with each hash.

The controller 305 may analyze and rank each hash stored in the primary hash list 310 based on one or more criteria (e.g., characteristics). For example, the one or more criteria may be based on a characteristic of a respective hash itself, based on environmental considerations (e.g., a characteristic of a respective network 110 associated with the hash), or based on a predicted reward (e.g., operational achievement) associated with unhashing the hash. In some examples, the controller 305 may use a ranking algorithm to consider the ranking criteria and to determine a respective priority of each hash received from the autonomous pentesting agents 105. In some examples, the controller 305 may store one or more hashes associated with different clients (e.g., different networks 110) in a same queue 315 (e.g., based on priorities of the one or more hashes being relatively similar). In some examples, an order of hashes within each queue 315 may be based on relative priority values of each hash within the queue, based on an order in which each hash was obtained, or both.

In some examples, the controller 305 may rank hashes based on assigning a respective priority value to each hash based on the one or more criteria (e.g., where a relatively larger priority value corresponds to a relatively higher priority hash, or vice versa). For example, the controller 305 may determine that a first hash received from the autonomous pentesting agent 105-a is associated with a first priority value, that a second hash received from the autonomous pentesting agent 105-a is associated with a second priority value that is lower than the first priority value, and that a third hash received from the autonomous pentesting agent 105-b is associated with a third priority value that is lower than the first priority value and higher than the second priority value. The controller 305 may accordingly store the first hash and the third hash in the highest priority queue (e.g., the queue 315-a) and the second hash in a lower priority queue (e.g., the queue 315-b). In some examples, each queue 315 may be associated with one or more priority thresholds. For example, the controller 305 may store the first hash and the third hash in the queue 315-a based on the first priority and the third priority satisfying a first priority threshold associated with the queue 315-a, and may store the second hash in the queue 315-b based on the second priority failing to satisfy the first priority threshold (e.g., and based on the second priority satisfying a second priority threshold associated with the queue 315-b).

In examples in which the one or more criteria are based on a characteristic of the respective hash itself, the criteria may be based on an estimated difficulty associated with a respective hash satisfying a threshold difficulty. Different hash types (such as new technology local area network (LAN) manager (NTLM), message-digest algorithm (MD5), Secure Hash Algorithm 256-bit (SHA256) Crypt, bcrypt, and others) may be associated with different levels of complexity, and may be accordingly relatively more or less easy to crack. In such examples, the controller 305 may sort a hash associated with a relatively more difficult hash type to unhash (such as a hash generated using a bcrypt hashing algorithm that uses salting and multiple rounds of hashing to increase a difficulty of cracking) in the queue 315-n, and a hash associated with a relatively less difficult hash type to unhash (such as a hash generated using a Windows NTLM hashing algorithm that may not use salting) in the queue 315-a.

Additionally, or alternatively, the estimated difficulty may be based on an expected duration associated with unhashing the hash. The controller 305 may compute expected duration associated with unhashing each hash, and may sort a hash associated with a relatively longer unhashing duration in the queue 315-b and a hash associated with a relative shorter unhashing duration in the queue 315-a. In some examples, each queue 315 may be associated with one or more respective cracking durations. For example, the controller 305 may store one or more hashes associated with a cracking duration that is less than a first threshold in the queue 315-a, one or more hashes associated with a cracking duration that is greater than the first threshold and less than a second threshold in the queue 315-a, and one or more hashes associated with a cracking duration that is greater than the second threshold in the queue 315-n.

Additionally, or alternatively, in examples in which the one or more criteria are based on environmental considerations, the criteria may be based on a credential privilege level associated with the hash (e.g., environmental permissions of a credential that the hash belongs to). For example, a hash with a relatively higher privilege level (e.g., a privilege level above a threshold, such as a domain administrator) may be stored in the queue 315-a, and a hash with a relatively lower privilege level (e.g., a privilege level below the threshold, such as a local administrator) may be stored in the queue 315-b. The autonomous pentesting agents 105 may obtain such environmental information during a course of a pentest (e.g., via Window Active Directory permission sets for each user of a client). Separately, the autonomous pentesting agents 105 may obtain a password hash of a user (e.g., via misconfiguration or via a vulnerability). The autonomous pentesting agents 105 may determine if known permissions of the user are privileged and high-value (e.g., domain administrator permissions), and may accordingly indicate, to the controller 305, permissions metadata associated with the user (e.g., a permissions level of the user) along with the hash. The controller 305 may accordingly use the permissions metadata to determine a rank (e.g., priority) of the hash.

Additionally, or alternatively, in examples in which the one or more criteria are based on environmental considerations, the criteria may be based on one or more client-or pentest administrator-specific considerations. For example, a client or a pentest administrator associated with a given network 110 may provide one or more additional criteria, such as a specific user or type of hash to prioritize unhashing for the given network 110. Accordingly, the controller 305 may adjust (e.g., tune) the priority associated with hashes obtained from the network 110 based on the client- or pentest administrator-specific considerations.

Additionally, or alternatively, in examples in which the one or more criteria are based on a predicted reward, the criteria may be based on a perceived client value associated with the hash (e.g., based on real-time operational context of all clients with hashes in the queues 315). For example, the controller 305 may determine a perceived outcome of an operation associated with cracking a given hash. The controller 305 may store a hash with a relatively higher likelihood to result in an operational achievement (e.g., a domain compromise) in the queue 315-a, and a hash with a relatively lower likelihood to result in the operational achievement in the queue 315-b. In some examples, if domain rights or a domain compromise have not been achieved by a pentest for a first client, and domain rights or a domain compromise have been achieved by a pentest for a second client, the controller 305 may store one or more hashes associated with the first client in relatively higher priority queues than one or more hashes associated with the second client.

Additionally, or alternatively, in examples in which the one or more criteria are based on environmental considerations, the criteria may be based on a client priority level associated with the hash. The client priority level may be based on a license or subscription level associated with a client. For example, the controller 305 may store a first hash associated with a relatively higher priority client in the queue 315-a, and a second hash with a relatively lower priority client in the queue 315-b. In some examples, the higher priority client may have access to relatively more queues (e.g., or relatively higher priority queues) based on the license or subscription level. In some examples, the higher priority client may have relatively more prioritized access to a given set of queues (e.g., a set of relatively higher priority queues).

In some examples, the controller 305 may use the ranking algorithm to re-rank (e.g., continuously or dynamically re-rank) the hashes stored in each queue 315. For example, one or more pentest results (e.g., operational achievements such as domain compromise) may be obtained by the autonomous pentesting agents 105 that may influence the relative priorities of each hash. For example, as a result of such an operational achievement of a first client, a value associated with cracking additional hashes of the first client may decrease in relation to unhashing additional hashes of one or more other clients. The controller 305 may de-prioritize and re-rank password hashes in each queue 315 such that hashes associated with the first client are ranked lower than hashes to be processed that are associated with the other clients. In some examples, the controller 305 may obtain information that indicates that a hash in a higher priority queue 315-a has devalued the cracking of the hash. The controller 305 may accordingly cancel a hash cracking operation associated with the hash and/or move the hash to a lower priority queue 315-n.

In some examples, re-ranking the hashes may include a granular re-ranking such as adjusting a respective priority value associated with each hash (e.g., in examples in which the controller 305 determines the respective priority value) or a binary re-ranking such as moving a hash to a different queue. In examples in which the controller 305 performs a granular re-ranking, an amount in which the priority value changes may be based on the one or more pentest results or based on the obtained information. As an illustrative example, if an operational achievement of a first client occurs that significantly devalues unhashing a first hash, the controller 305 may adjust a priority value of the first hash associated with the first client from a 5 (e.g., a relatively higher priority) to a 2 (e.g., a relatively lower priority). Additionally, or alternatively, if information is obtained that indicates that the value of the first hash is slightly decreased, the controller 305 may adjust the priority value of the first hash from a 5 to a 4.

As an illustrative example, the controller 305 may receive a non-privileged credential hash from the autonomous pentesting agent 105-a associated with the network 110-a (e.g., associated with a first client). The controller 305 may store the non-privileged credential hash in the queue 315-n. The controller 305 may receive a first privileged credential hash associated with the first client and may store the first privileged credential hash in the queue 315-a. The controller 305 may receive a second privileged credential hash associated with the first client that is associated with a relatively higher difficulty than the first privileged credential hash and may therefore store the second privileged credential hash in the queue 315-b. The controller 305 may receive a third privileged credential hash from the autonomous pentesting agent 105-b associated with the network 110-b (e.g., associated with a second client), and may store the third privileged credential hash in the queue 315-a. In response to an operational achievement (e.g., in response to the pentest of the first client fully compromising the network 110-a), the controller 305 may re-rank the hashes to place the hashes associated with the second client higher in priority than the hashes associated with the first client (e.g., due to a perceived increase in reward associated with unhashing the hashes associated with the second client). For example, the controller 305 may move the hashes associated with the first client to the queue 315-n.

In some examples, the controller 305 may use the hash cracking algorithm to continuously process all hashes in the highest priority queue (e.g., the queue 315-a) until the highest priority queue is exhausted (e.g., until all hashes in the highest priority queue are cracked). The controller 305 may then use the hash cracking algorithm to crack one or more hashes in the next priority queue (e.g., the queue 315-b).

Additionally, or alternatively, the controller 305 may implement a client-based prioritization procedure as part of the multi-agent pentest that may adjust the hash cracking procedure to account for client fairness. For example, the controller 305 may unhash one or more hashes stored in a lower priority queue prior to exhausting the higher priority queue, or may change an order of hashes within a given queue, to account for client fairness.

For example, the controller 305 may receive relatively more hashes from the autonomous pentesting agent 105-a (e.g., hashes of the hash set 320-a associated with a first client) as compared to hashes received from the autonomous pentesting agent 105-b (e.g., hashes of the hash set 320-b associated with a second client). The hashes of the hash set 320-a may accordingly saturate the primary hash list 310. In such examples, to reduce saturation by the first client (e.g., to reduce a ratio of hashes cracked for the first client relative to the second client), the hash cracking function of the controller 305 may implement a client-based prioritization for hash cracking (e.g., within a queue or across queues). That is, the controller 305 may unhash one or more hashes associated with a second client (e.g., one or more hashes lower in a queue or in a lower priority queue) before unhashing all hashes associated with a first client to prevent the first client from saturating the multi-agent pentest. For example, the controller 305 may unhash a threshold quantity of hashes associated with the first client, and may then unhashing one or more hashes associated with the second client (e.g., based on the second client being different from the first client) before unhashing one or more additional hashes associated with the first client.

As an illustrative example, the controller 305 may store 10 hashes associated with the first client in the queue 315-a and 5 hashes associated with the second client in the queue 315-a following the 10 hashes associated with the first client. The hash cracking function may accordingly unhash a first hash associated with the first client, and may unhash a first hash associated with the second client prior to unhashing a second hash associated with the first client (e.g., regardless of the order in which the hashes are stored in the queue 315-a).

As an additional illustrative example, the controller 305 may store ten hashes associated with the first client in the queue 315-a and two hashes associated with the second client in the queue 315-b. The hash cracking function may accordingly unhash five hashes in the queue 315-a associated with the first client. The hash cracking function may then unhash a first hash in the queue 315-b associated with the second client prior to unhashing the remaining 5 hashes in the queue 315-a associated with the first client.

In some examples, the hash cracking algorithm may include one or more parameters (e.g., a time allotted for unhashing, one or more rules used when performing unhashing, one or more wordlists used for unhashing) that may be adjusted or tuned based on a priority of a respective hash and/or a potential reward (e.g., a likelihood of an operational achievement) associated with the respective hash. For example, the hash cracking algorithm may allot relatively more time to unhashing a hash for which a potential reward associated with unhashing the hash is domain compromise, and relatively less time to unhashing a hash associated with a client for which a pentest has already achieved domain compromise. In some examples, the hash cracking algorithm may use a default value of the parameters (e.g., 5 minutes for an allotted cracking duration), and may dynamically adjust the value of the parameters based on the priority associated with a queue 315 in which the hash cracking algorithm attempts to unhash one or more hashes. In some examples, the hash cracking algorithm may use a wordlist for unhashing until the wordlist is exhausted. The hash cracking algorithm may then use one or more rules in addition to the wordlist until the wordlist and rules are again exhausted. The hash cracking algorithm may then use a brute force unhashing method (e.g., up to a character limit).

In some examples, the controller 305 may use one or more resources or pools (e.g., resources in a cloud system) for implementing priority-based hash crack queuing. The controller 305 may expand a pool of resources and/or increase an allotted cracking duration based on a priority of a respective queue. In some examples, the hash cracking algorithm may use parallelization (e.g., using multiple computing units or processors simultaneously) for cracking a single hash (e.g., if a perceived reward or likelihood of an operational achievement is above a threshold). In some examples, the controller 305 may route one or more higher priority hashes or queues to physical hardware (e.g., rather than cloud systems or resources), which may result in relatively faster unhashing operations (e.g., to speed up or improve cracking time).

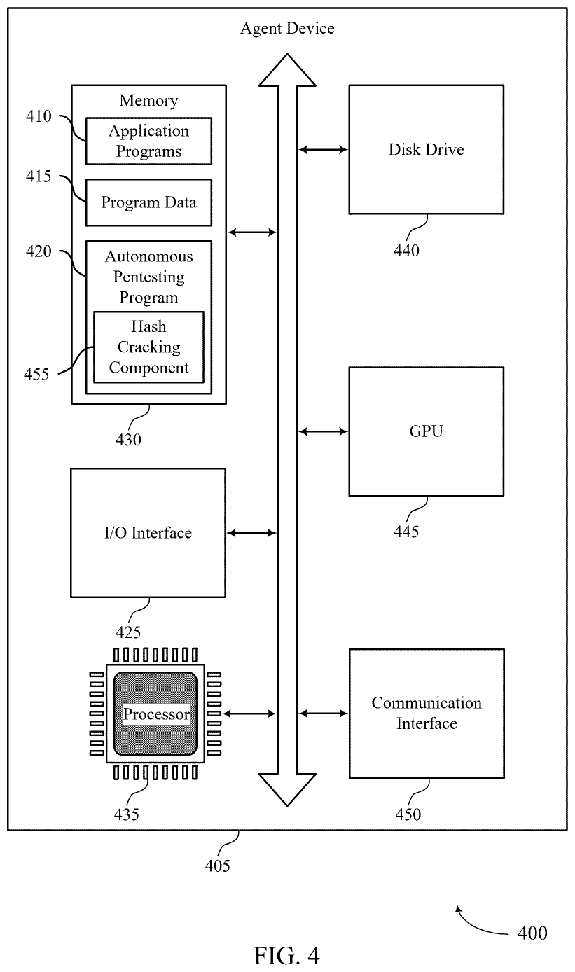

FIG. 4 shows a diagram of a system 400 including an agent device 405 that supports priority-based hash cracking for penetration testing in accordance with aspects of the present disclosure. The agent device 405 may be an example of a device or server on which an autonomous pentesting agent 105 is deployed as described herein. The agent device 405 may include components for priority-based hash cracking for penetration testing, such as a memory 430 including application programs 410, program data 415, an autonomous pentesting program 420, and a hash cracking component 455; an input/output (I/O) interface 425; a processor 435; a disk drive 440; a graphics processing unit (GPU) 445; and a communication interface 450. Each of these components may communicate, directly or indirectly, with one another (e.g., via one or more buses, communications links, communications interfaces, or any combination thereof).

The I/O interface 425 may support connection of the agent device 405 with one or more other devices. For example, the agent device 405 may connect to keyboards, mice, printers, hard disks, or the like via the I/O interface 425. The I/O interface 425 may communicate with the processor 435. That is, the processor 435 may process signals from devices connected to the agent device 405 via the I/O interface 425.

Memory 430 may include RAM, ROM, or both. The memory 430 may store computer-readable, computer-executable software including instructions that, when executed, cause at least one processor 435 to perform various functions described herein, such as functions supporting priority-based hash cracking for penetration testing. In some cases, the memory 430 may contain, among other things, a basic input/output system (BIOS), which may control basic hardware or software operation such as the interaction with peripheral components or devices. The memory 430 may be an example of a single memory or multiple memories. For example, the agent device 405 may include one or more memories 430.

The application programs 410 in the memory 430 may be examples of app(s) 140 as described with reference to FIG. 1. For example, the application programs 410 may be installed on the memory 430 of the agent device 405, among other devices in a network. The application programs 410 may be examples of software applications or computer programs that are implemented to carry out one or more functions or tasks.

The program data 415 may be data related to the application programs 410. Program data 415 may be an example of or refer to running data of programs and applications installed on the memory 430 of the agent device 405. In some examples, the program data 415 may include various data, including code that allows the application programs 410 to perform the one or more functions or tasks.

The processor 435 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 435 may be configured to execute computer-readable instructions stored in at least one memory 430 to perform various functions (e.g., functions or tasks supporting priority-based hash cracking for penetration testing). Though a single processor 435 is depicted in the example of FIG. 4, it is to be understood that the system 400 may include any quantity of one or more of processors 435 and that a group of processors 435 may collectively perform one or more functions ascribed herein to a processor, such as the processor 435. The processor 435 may be an example of a single processor or multiple processors. For example, the agent device 405 may include one or more processors 435.

The disk drive 440 may be configured to store data that is generated, processed, stored, or otherwise used by the system 400. In some cases, the disk drive 440 may include one or more hard disk drives (HDDs), one or more solid-state drives (SSDs), or both. In some examples, the disk drive 440 may be an example of a single database, a distributed database, multiple distributed databases, a data store, a data lake, or an emergency backup database. In some examples, the disk drive 440 may be an example of one or more components described with reference to FIG. 1.

The GPU 445 may be configured to store graphics-related data. The GPU 445 may store and manage data related to graphics and video processing. In some examples, the GPU 445 may be an example of or a component of a graphics card. The GPU 445 may use components of the memory 430, including the RAM, for temporary storage. For example, the GPU 445 may move data from the RAM of the memory 430 to the GPU 445 for graphics and video processing.

The communication interface 450 may enable the agent device 405 to exchange information (e.g., input information, output information, or both) with other systems or devices (not shown). For example, the communication interface 450 may enable the agent device 405 to connect to a network (e.g., a network 110 as described herein). The communication interface 450 may include one or more wireless network interfaces, one or more wired network interfaces, or any combination thereof.

The autonomous pentesting program 420 may be an example of a program of an autonomous pentesting service that is installed on the memory 430 of the agent device 405. The autonomous pentesting program 420 may execute an autonomous pentest of a network accessed by the agent device 405, such as accessed via the communication interface 450. That is, the autonomous pentesting program 420 may be configured to perform an autonomous pentest as described herein, including an autonomous pentest involving priority-based hash cracking.

The hash cracking component 455 may support priority-based hash cracking in accordance with examples as disclosed herein. For example, the hash cracking component 455 may be configured as or otherwise support a means for obtaining a set of password hashes associated with performing one or more penetration tests of one or more clients. The hash cracking component 455 may be configured as or otherwise support a means for storing a first subset of the set of password hashes in a first queue based at least in part on the first subset of the set of password hashes satisfying one or more first criteria associated with performing the one or more penetration tests, the first queue associated with a first priority. The hash cracking component 455 may be configured as or otherwise support a means for storing a second subset of the set of password hashes in a second queue based at least in part on the second subset of the set of password hashes satisfying one or more second criteria, the second queue associated with a second priority lower than the first priority. The hash cracking component 455 may be configured as or otherwise support a means for unhashing, via a hash cracking function and as part of the one or more penetration tests, at least one password hash of the first subset of the set of password hashes based at least in part on the first priority being higher than the second priority. The hash cracking component 455 may be configured as or otherwise support a means for unhashing, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.

By including or configuring the hash cracking component 455 in accordance with examples as described herein, the agent device 405 may support techniques for improved network security.

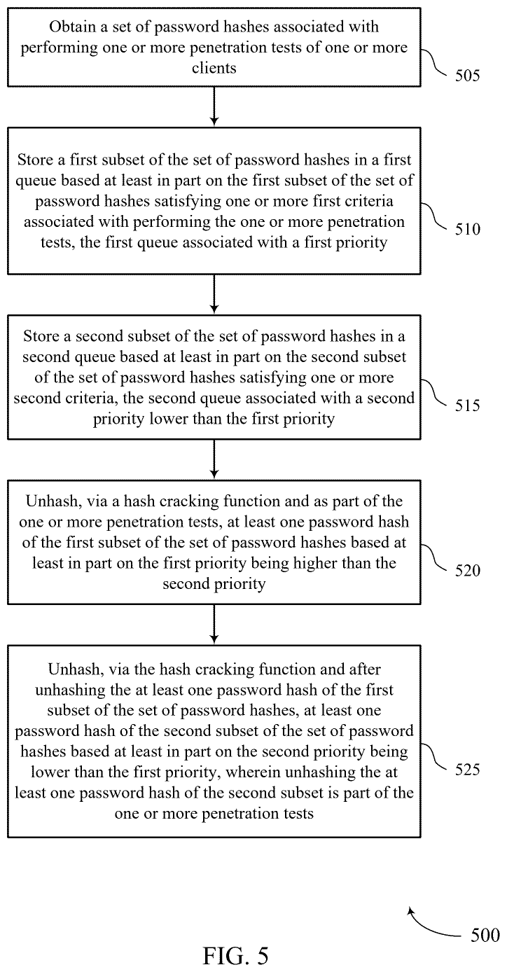

FIG. 5 shows a flowchart illustrating a method 500 that supports priority-based hash cracking for penetration testing in accordance with aspects of the present disclosure. The operations of the method 500 may be implemented by an agent device 405 or its components as described herein. In some examples, an agent device may execute a set of instructions to control the functional elements of the agent device to perform the described functions. Additionally, or alternatively, the agent device may perform aspects of the described functions using special-purpose hardware.

At 505, the method may include obtaining a set of password hashes associated with performing one or more penetration tests of one or more clients. The operations of 505 may be performed in accordance with examples as disclosed herein. In some examples, aspects of the operations of 505 may be performed by a hash cracking component 455 as described with reference to FIG. 4.

At 510, the method may include storing a first subset of the set of password hashes in a first queue based at least in part on the first subset of the set of password hashes satisfying one or more first criteria associated with performing the one or more penetration tests, the first queue associated with a first priority. The operations of 510 may be performed in accordance with examples as disclosed herein. In some examples, aspects of the operations of 510 may be performed by a hash cracking component 455 as described with reference to FIG. 4.

In some examples, the one or more first criteria may include an estimated difficulty associated with unhashing the password hashes of the first subset. For example, the estimated difficulty may be based on a hash type associated with the first subset, a duration associated with unhashing the password hashes of the first subset, or both. In some examples, the one or more first criteria may include a privilege level associated with the first subset satisfying a threshold privilege level, a likelihood of an operational achievement associated with unhashing the password hashes of the first subset satisfying a threshold likelihood, a priority level associated with the first subset satisfying a threshold priority level, or any combination thereof.

At 515, the method may include storing a second subset of the set of password hashes in a second queue based at least in part on the second subset of the set of password hashes satisfying one or more second criteria, the second queue associated with a second priority lower than the first priority. The operations of 515 may be performed in accordance with examples as disclosed herein. In some examples, aspects of the operations of 515 may be performed by a hash cracking component 455 as described with reference to FIG. 4.

At 520, the method may include unhashing, via a hash cracking function and as part of the one or more penetration tests, at least one password hash of the first subset of the set of password hashes based at least in part on the first priority being higher than the second priority. The operations of 520 may be performed in accordance with examples as disclosed herein. In some examples, aspects of the operations of 520 may be performed by a hash cracking component 455 as described with reference to FIG. 4.

At 525, the method may include unhashing, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests. The operations of 525 may be performed in accordance with examples as disclosed herein. In some examples, aspects of the operations of 525 may be performed by a hash cracking component 455 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor) for obtaining a set of password hashes associated with performing one or more penetration tests of one or more clients, storing a first subset of the set of password hashes in a first queue based at least in part on the first subset of the set of password hashes satisfying one or more first criteria associated with performing the one or more penetration tests, the first queue associated with a first priority, storing a second subset of the set of password hashes in a second queue based at least in part on the second subset of the set of password hashes satisfying one or more second criteria, the second queue associated with a second priority lower than the first priority, unhashing, via a hash cracking function and as part of the one or more penetration tests, at least one password hash of the first subset of the set of password hashes based at least in part on the first priority being higher than the second priority, and unhashing, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.

In some examples of the method 500 and the apparatus described herein, the one or more first criteria include an estimated difficulty associated with unhashing the password hashes of the first subset and the estimated difficulty may be based at least in part on a hash type associated with the first subset, a duration associated with unhashing the password hashes of the first subset, or any combination thereof.

In some examples of the method 500 and the apparatus described herein, the one or more first criteria include a privilege level associated with the first subset satisfying a threshold privilege level, a likelihood of an operational achievement associated with unhashing the password hashes of the first subset satisfying a threshold likelihood, a priority level associated with the first subset satisfying a threshold priority level, or any combination thereof.

Some examples of the method 500 and the apparatus described herein may further include operations, features, means, or instructions for moving a first password hash of the first subset to the second queue based at least in part on an operational achievement of a penetration test of a first client, wherein the first password hash may be associated with the first client.

Some examples of the method 500 and the apparatus described herein may further include operations, features, means, or instructions for storing a third subset of the set of password hashes in a third queue, the third queue associated with a third priority lower than the second priority.

In some examples of the method 500 and the apparatus described herein, the first subset may be associated with a first hash cracking duration that may be less than a first threshold hash cracking duration associated with the first queue, the second subset may be associated with a second hash cracking duration that may be greater than the first threshold hash cracking duration and may be less than a second threshold hash cracking duration associated with the second queue, and the third subset may be associated with a third hash cracking duration that may be greater than the second threshold hash cracking duration.

In some examples of the method 500 and the apparatus described herein, unhashing the at least one password hash of the second subset may include operations, features, circuitry, logic, means, or instructions for unhashing the at least one password hash of the second subset before unhashing all of the password hashes of the first subset based at least in part on the at least one password hash of the second subset being associated with a second client that may be different from a first client associated with the at least one password hash of the first subset.

In some examples of the method 500 and the apparatus described herein, unhashing the at least one password hash of the first subset may include operations, features, circuitry, logic, means, or instructions for unhashing a threshold quantity of password hashes associated with a first client and unhashing one or more password hashes associated with a second client based at least in part on unhashing the threshold quantity of password hashes associated with the first client.

In some examples of the method 500 and the apparatus described herein, obtaining the set of password hashes may include operations, features, circuitry, logic, means, or instructions for obtaining, via a first operation associated with a first client, a first set of password hashes and obtaining, via a second operation associated with a second client, a second set of password hashes, the set of password hashes including the first set of password hashes and the second set of password hashes.

The following provides an overview of aspects of the present disclosure:
Aspect 1: A method for unhashing password hashes, comprising: obtaining a set of password hashes associated with performing one or more penetration tests of one or more clients; storing a first subset of the set of password hashes in a first queue based at least in part on the first subset of the set of password hashes satisfying one or more first criteria associated with performing the one or more penetration tests, the first queue associated with a first priority; storing a second subset of the set of password hashes in a second queue based at least in part on the second subset of the set of password hashes satisfying one or more second criteria, the second queue associated with a second priority lower than the first priority; unhashing, via a hash cracking function and as part of the one or more penetration tests, at least one password hash of the first subset of the set of password hashes based at least in part on the first priority being higher than the second priority; and unhashing, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.
Aspect 2: The method of aspect 1, wherein the one or more first criteria comprise an estimated difficulty associated with unhashing the password hashes of the first subset, the estimated difficulty is based at least in part on a hash type associated with the first subset, a duration associated with unhashing the password hashes of the first subset, or any combination thereof.
Aspect 3: The method of any of aspects 1 through 2, wherein the one or more first criteria comprise a privilege level associated with the first subset satisfying a threshold privilege level, a likelihood of an operational achievement associated with unhashing the password hashes of the first subset satisfying a threshold likelihood, a priority level associated with the first subset satisfying a threshold priority level, or any combination thereof.
Aspect 4: The method of any of aspects 1 through 3, further comprising: moving a first password hash of the first subset to the second queue based at least in part on an operational achievement of a penetration test of a first client, wherein the first password hash is associated with the first client.
Aspect 5: The method of any of aspects 1 through 4, further comprising: storing a third subset of the set of password hashes in a third queue, the third queue associated with a third priority lower than the second priority.
Aspect 6: The method of aspect 5, wherein the first subset is associated with a first hash cracking duration that is less than a first threshold hash cracking duration associated with the first queue, the second subset is associated with a second hash cracking duration that is greater than the first threshold hash cracking duration and is less than a second threshold hash cracking duration associated with the second queue, and the third subset is associated with a third hash cracking duration that is greater than the second threshold hash cracking duration.
Aspect 7: The method of any of aspects 1 through 6, wherein unhashing the at least one password hash of the second subset comprises: unhashing the at least one password hash of the second subset before unhashing all of the password hashes of the first subset based at least in part on the at least one password hash of the second subset being associated with a second client that is different from a first client associated with the at least one password hash of the first subset.
Aspect 8: The method of any of aspects 1 through 7, wherein unhashing the at least one password hash of the first subset comprises: unhashing a threshold quantity of password hashes associated with a first client; and unhashing one or more password hashes associated with a second client based at least in part on unhashing the threshold quantity of password hashes associated with the first client.
Aspect 9: The method of any of aspects 1 through 8, wherein obtaining the set of password hashes comprises: obtaining, via a first operation associated with a first client, a first set of password hashes; and obtaining, via a second operation associated with a second client, a second set of password hashes, the set of password hashes comprising the first set of password hashes and the second set of password hashes.
Aspect 10: An apparatus for unhashing password hashes, comprising one or more memories storing processor-executable code, and one or more processors coupled with the one or more memories and individually or collectively operable to execute the code to cause the apparatus to perform a method of any of aspects 1 through 9.
Aspect 11: An apparatus for unhashing password hashes, comprising at least one means for performing a method of any of aspects 1 through 9.
Aspect 12: A non-transitory computer-readable medium storing code for unhashing password hashes, the code comprising instructions executable by one or more processors to perform a method of any of aspects 1 through 9.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for unhashing password hashes, comprising:
obtaining a set of password hashes associated with performing one or more penetration tests of one or more clients;
storing a first subset of the set of password hashes in a first queue based at least in part on the first subset of the set of password hashes satisfying one or more first criteria associated with performing the one or more penetration tests, the first queue associated with a first priority;
storing a second subset of the set of password hashes in a second queue based at least in part on the second subset of the set of password hashes satisfying one or more second criteria, the second queue associated with a second priority lower than the first priority;
unhashing, via a hash cracking function and as part of the one or more penetration tests, at least one password hash of the first subset of the set of password hashes based at least in part on the first priority being higher than the second priority; and
unhashing, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.

2. The method of claim 1, wherein the one or more first criteria comprise an estimated difficulty associated with unhashing the password hashes of the first subset, and wherein the estimated difficulty is based at least in part on a hash type associated with the first subset, a duration associated with unhashing the password hashes of the first subset, or any combination thereof.

3. The method of claim 1, wherein the one or more first criteria comprise a privilege level associated with the first subset satisfying a threshold privilege level, a likelihood of an operational achievement associated with unhashing the password hashes of the first subset satisfying a threshold likelihood, a priority level associated with the first subset satisfying a threshold priority level, or any combination thereof.

4. The method of claim 1, further comprising:
moving a first password hash of the first subset to the second queue based at least in part on an operational achievement of a penetration test of a first client, wherein the first password hash is associated with the first client.

5. The method of claim 1, further comprising:
storing a third subset of the set of password hashes in a third queue, the third queue associated with a third priority lower than the second priority.

6. The method of claim 5, wherein the first subset is associated with a first hash cracking duration that is less than a first threshold hash cracking duration associated with the first queue, the second subset is associated with a second hash cracking duration that is greater than the first threshold hash cracking duration and is less than a second threshold hash cracking duration associated with the second queue, and the third subset is associated with a third hash cracking duration that is greater than the second threshold hash cracking duration.

7. The method of claim 1, wherein unhashing the at least one password hash of the second subset comprises:
unhashing the at least one password hash of the second subset before unhashing all of the password hashes of the first subset based at least in part on the at least one password hash of the second subset being associated with a second client that is different from a first client associated with the at least one password hash of the first subset.

8. The method of claim 1, wherein unhashing the at least one password hash of the first subset comprises:
unhashing a threshold quantity of password hashes associated with a first client; and
unhashing one or more password hashes associated with a second client based at least in part on unhashing the threshold quantity of password hashes associated with the first client.

9. The method of claim 1, wherein obtaining the set of password hashes comprises:
obtaining, via a first operation associated with a first client, a first set of password hashes; and
obtaining, via a second operation associated with a second client, a second set of password hashes, the set of password hashes comprising the first set of password hashes and the second set of password hashes.

10. An apparatus for unhashing password hashes, comprising:
one or more memories storing processor-executable code; and
one or more processors coupled with the one or more memories and individually or collectively operable to execute the code to cause the apparatus to:
obtain a set of password hashes associated with performing one or more penetration tests of one or more clients;
store a first subset of the set of password hashes in a first queue based at least in part on the first subset of the set of password hashes satisfying one or more first criteria associated with performing the one or more penetration tests, the first queue associated with a first priority;
store a second subset of the set of password hashes in a second queue based at least in part on the second subset of the set of password hashes satisfying one or more second criteria, the second queue associated with a second priority lower than the first priority;
unhash, via a hash cracking function and as part of the one or more penetration tests, at least one password hash of the first subset of the set of password hashes based at least in part on the first priority being higher than the second priority; and
unhash, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.

11. The apparatus of claim 10, wherein the one or more first criteria comprise an estimated difficulty associated with unhashing the password hashes of the first subset, and wherein the estimated difficulty is based at least in part on a hash type associated with the first subset, a duration associated with unhashing the password hashes of the first subset, or any combination thereof.

12. The apparatus of claim 10, wherein the one or more first criteria comprise a privilege level associated with the first subset satisfying a threshold privilege level, a likelihood of an operational achievement associated with unhashing the password hashes of the first subset satisfying a threshold likelihood, a priority level associated with the first subset satisfying a threshold priority level, or any combination thereof.

13. The apparatus of claim 10, wherein the one or more processors are individually or collectively further operable to execute the code to cause the apparatus to:
move a first password hash of the first subset to the second queue based at least in part on an operational achievement of a penetration test of a first client, wherein the first password hash is associated with the first client.

14. The apparatus of claim 10, wherein the one or more processors are individually or collectively further operable to execute the code to cause the apparatus to:
store a third subset of the set of password hashes in a third queue, the third queue associated with a third priority lower than the second priority.

15. The apparatus of claim 14, wherein the first subset is associated with a first hash cracking duration that is less than a first threshold hash cracking duration associated with the first queue, the second subset is associated with a second hash cracking duration that is greater than the first threshold hash cracking duration and is less than a second threshold hash cracking duration associated with the second queue, and the third subset is associated with a third hash cracking duration that is greater than the second threshold hash cracking duration.

16. The apparatus of claim 10, wherein, to unhash the at least one password hash of the second subset, the one or more processors are individually or collectively operable to execute the code to cause the apparatus to:
unhash the at least one password hash of the second subset before unhashing all of the password hashes of the first subset based at least in part on the at least one password hash of the second subset being associated with a second client that is different from a first client associated with the at least one password hash of the first subset.

17. The apparatus of claim 10, wherein, to unhash the at least one password hash of the first subset, the one or more processors are individually or collectively operable to execute the code to cause the apparatus to:
unhash a threshold quantity of password hashes associated with a first client; and
unhash one or more password hashes associated with a second client based at least in part on unhashing the threshold quantity of password hashes associated with the first client.

18. The apparatus of claim 10, wherein, to obtain the set of password hashes, the one or more processors are individually or collectively operable to execute the code to cause the apparatus to:
obtain, via a first operation associated with a first client, a first set of password hashes; and
obtain, via a second operation associated with a second client, a second set of password hashes, the set of password hashes comprising the first set of password hashes and the second set of password hashes.

19. A non-transitory computer-readable medium storing code for unhashing password hashes, the code comprising instructions executable by one or more processors to:
obtain a set of password hashes associated with performing one or more penetration tests of one or more clients;
store a first subset of the set of password hashes in a first queue based at least in part on the first subset of the set of password hashes satisfying one or more first criteria associated with performing the one or more penetration tests, the first queue associated with a first priority;
store a second subset of the set of password hashes in a second queue based at least in part on the second subset of the set of password hashes satisfying one or more second criteria, the second queue associated with a second priority lower than the first priority;
unhash, via a hash cracking function and as part of the one or more penetration tests, at least one password hash of the first subset of the set of password hashes based at least in part on the first priority being higher than the second priority; and
unhash, via the hash cracking function and after unhashing the at least one password hash of the first subset of the set of password hashes, at least one password hash of the second subset of the set of password hashes based at least in part on the second priority being lower than the first priority, wherein unhashing the at least one password hash of the second subset is part of the one or more penetration tests.

20. The non-transitory computer-readable medium of claim 19, wherein the one or more first criteria comprise an estimated difficulty associated with unhashing the password hashes of the first subset, and wherein the estimated difficulty is based at least in part on a hash type associated with the first subset, a duration associated with unhashing the password hashes of the first subset, or any combination thereof.
